(19) United States
(12) Patent Application Publication
(10) Pub. No.: US 2014/0066034 A1
(43) Pub. Date: Mar. 6, 2014

(54) APPARATUS AND METHOD FOR DISPLAYING CALLBACK INFORMATION

(71) Applicant: Pantech Co., Ltd., Seoul (KR)

(72) Inventor: Changbae BANG, Seoul (KR)

(73) Assignee: Pantech Co., Ltd., Seoul (KR)

(21) Appl. No.: 13/975,931

(22) Filed: Aug. 26, 2013

(30) Foreign Application Priority Data
Aug. 31, 2012 (KR) 10-2012-0096404

(51) Int. Cl. H04M 1/57

(52) U.S. Cl. CPC H04M 1/57
USPC 455/415

(57) ABSTRACT

A method for displaying callback information in a mobile terminal having a processor includes receiving a request signal for displaying a screen of an application; obtaining a resulting value when a screen address of the screen corresponds with a callback function address; and displaying callback information corresponding to the callback function address using the resulting value. An apparatus to display callback information including an input unit to receive a request signal to display a screen of an application; a calling unit to obtain a resulting value when a screen address of the screen corresponds with a callback function address; and a displaying unit to display callback information corresponding to the callback function address using the resulting value.

### CROSS-REFERENCE TO RELATED APPLICATION

This application claims priority to and the benefit under 35 U.S.C. §119(a) of Korean Patent Application No. 10-2012-0096404, filed on Aug. 31, 2012, the entire disclosure of which is incorporated by reference for all purposes.

### BACKGROUND

1. Field

The following disclosure relates to an apparatus and a method for displaying callback information of an application.

2. Discussion of the Background

Application markets, for example, the App Store® of Apple® and the like, provided by a mobile terminal manufacturers, third party vendors, or a mobile telecommunication service providers, are emerging as an application distributor as distribution of mobile communication terminals are becoming more widespread. When content developers produce an application for commercial use, the respective application may be uploaded onto an application market for personal users to download and use.

The mobile terminal manufacturer may produce an application for the application to be installed on a terminal by default, according to a policy of the mobile telecommunication service provider, or provide an application in such a manner that the mobile telecommunication service provider assumes full accountability for testing and management.

Applications installed in a mobile communication terminal may provide various functions to a user by applying a callback function. Callback function may refer to an executable function, which may be executed at an application level.

A mobile communication terminal to which the callback function is applied may call a function of a system from an application, call a callback function implemented in an application to obtain information required for performing the function by the system, execute the function by utilizing the information obtained by the system through the callback function, and transfer a result of the executed function to the application.

A user may fail to verify or determine whether an application supports a corresponding function because, in general, the application may display a plurality of images on a display screen of the mobile communication terminal, and when a function provided by a system implemented by the callback function is executed the information about the function is not displayed. Although the application may support the corresponding function provided by the mobile communication terminal, the user may experience difficulty in determining whether the function of the mobile communication terminal is supported by the application based on information provided on the display screen.

### SUMMARY

Exemplary embodiments of the present invention provide an apparatus and a method for displaying callback information of an application.

Additional features of the invention will be set forth in the description which follows, and in part will be apparent from the description, or may be learned by practice of the invention.

Exemplary embodiments of the present invention provide a method for displaying callback information in a mobile terminal having a processor including receiving a request signal for displaying a screen of an application; obtaining a resulting value when a screen address of the screen corresponds with a callback function address; and displaying callback information corresponding to the callback function address using the resulting value.

Exemplary embodiments of the present invention provide an apparatus to display callback information including an input unit to receive a request signal to display a screen of an application; a calling unit to obtain a resulting value when a screen address of the screen corresponds with a callback function address; and a displaying unit to display callback information corresponding to the callback function address using the resulting value.

Exemplary embodiments of the present invention provide a mobile terminal including an application including a screen; a system to provide a function to be used by the application; and an apparatus to associate a screen address of the screen and a callback function address of the function, to receive a request signal to display the screen, and to obtain a resulting value when the screen address of the screen corresponds with the callback function address.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a block diagram illustrating a configuration of a mobile communication terminal according to an exemplary embodiment of the present invention.

FIG. 2 is a block diagram illustrating a configuration of an apparatus to display callback information according to an exemplary embodiment of the present invention.

FIG. 3 is a block diagram illustrating information flow between an apparatus to display callback information and an application according to an exemplary embodiment of the present invention.

FIG. 4 is a block diagram illustrating a configuration of a mobile communication terminal to display a near field communication (NFC) telephone book transferring icon according to an exemplary embodiment of the present invention.

FIG. 5 is a diagram illustrating a screen prior to an NFC telephone book transferring icon being displayed according to an exemplary embodiment of the present invention.

FIG. 6 is a diagram illustrating a screen displaying an NFC telephone book transferring icon according to an exemplary embodiment of the present invention.

FIG. 7 is a diagram illustrating a screen on which callback information is displayed in a form of an animation according to an exemplary embodiment of the present invention.

FIG. 8 is a block diagram illustrating a configuration of a mobile communication terminal to display a voice recognition icon of a camera application according to an exemplary embodiment of the present invention.

FIG. 9 is a diagram illustrating a screen on which a voice recognition icon is displayed according to an exemplary embodiment of the present invention.

FIG. 10 is a flowchart illustrating a method for displaying callback information according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be understood that when an element is referred to as being “connected to” another element, it can be directly connected to the other element, or intervening elements may be present. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

When it is determined that a detailed description related to a known function or configuration detailed description thereof may be omitted. Also, terminologies used herein may describe the exemplary embodiments of the present invention. However, they may be changed based on a user, the intent of an operator, or a custom.

According to exemplary embodiments of the present invention a mobile communication terminal to which a callback function is applied may display callback information, such as, at least one of an icon, an image, an animation, a notification and the like, as to whether a function provided by a system or a mobile communication terminal may be used on or is compatible with an application to which the callback function may be applied.

As used herein, a callback function may refer to a function being called when a predetermined event occurs. For example, a user may set a system to provide a notification message at a predetermined time, such that the system may send the notification message to the user at the predetermined time. The predetermined time may correspond to the predetermined event and the notification message may correspond to the function being called.

As another example, in peer-to-peer (P2P) data transmission technology between two terminals, a condition of transmitting data selected from a first terminal to a second terminal may be established when a distance between the two terminals is included in a predetermined distance or range of distances. Here, the predetermined distance may correspond to the predetermined event, and the transmission of the data selected from the first terminal to the second terminal may correspond to the function being called. However, aspects of the invention are not limited thereto.

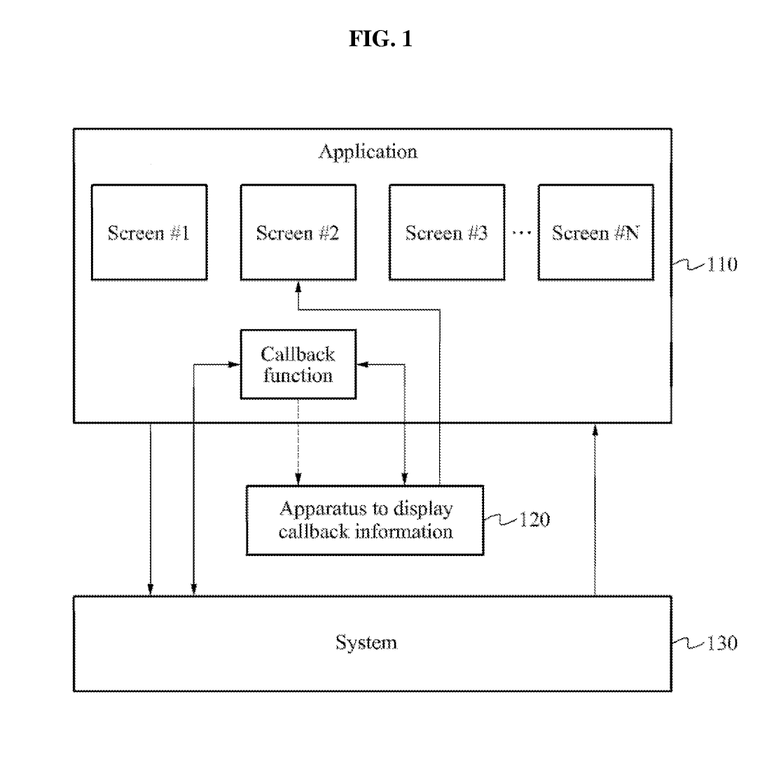

FIG. 1 is a block diagram illustrating a configuration of a mobile communication terminal according to an exemplary embodiment of the present invention.

Referring to FIG. 1, the mobile communication terminal to which the callback function is applied includes an apparatus 120 to display callback information and a system 130. The mobile communication terminal includes an application 110. Further, although not shown in FIG. 1, the mobile communication terminal may include hardware components, such as one or more processors, a memory, a touch screen display, a camera, and the like. Also, the units, modules, elements, devices, applications, and components of the apparatuses, systems, and/or mobile terminals herein described, may include hardware and software, may also include firmware, to perform various operations of the terminal including those described herein, may be combined or remain separate, and may be stored in one or more storage devices or computer-readable media. And, although described herein as a mobile communication terminal, aspects need not be limited thereto such that the mobile communication terminal may be a cellular telephone, a smartphone, a tablet computer, a laptop computer, a desktop computer, and the like.

The application 110 may be capable of using one or more functions provided by the system 130. The application 110 may include an implementation of the callback function, which may provide information used to execute the function.

The apparatus 120 to display the callback information may store and/or manage a screen address and a callback function address. More specifically, the apparatus 120 may store and/or manage a screen address of a screen of an application and a callback function associated with the screen address. Further, the apparatus 120 may determine whether implementing the callback function is possible and determine a resulting value prior or subsequent to calling. The apparatus 120 may display visual callback information on a screen automatically. However, aspects of the invention are not limited thereto, such that the apparatus 120 may display visual call back information in response to an input or condition.

The system 130 may provide a function of a mobile communication terminal or the system 130 that may commonly be used in some or all of a plurality of applications installed in the mobile communication terminal.

The apparatus 120 may display a function of a mobile communication terminal to which a callback function is applied, and hereinafter the callback function is provided as such, however, aspects of the invention are not limited thereto.

The system 130 may provide a function of the system 130 or a system function that may be commonly used by some or all of the plurality of applications. For example, the system function may be provided according to information flow, work flow, and the like. The system 130 may process information to be provided from one or more applications and a predetermined condition.

Application 110 may process a function of the system 130 or the mobile communication terminal with respect to the predetermined condition. The system 130 may call the callback function and receive information that may be used to execute the system function when processing the system function with respect to the predetermined condition.

The apparatus 120 may store and/or manage at least one of the screen address and the callback function address with respect to the screen provided by the application 110, such that the system 130 may call the callback function from or through the application 110. The stored or managed screen address and the callback function address may match or correspond to one another. When the system 130 requests the callback function, the apparatus 120 may display the screen and the callback information through a matching information relationship.

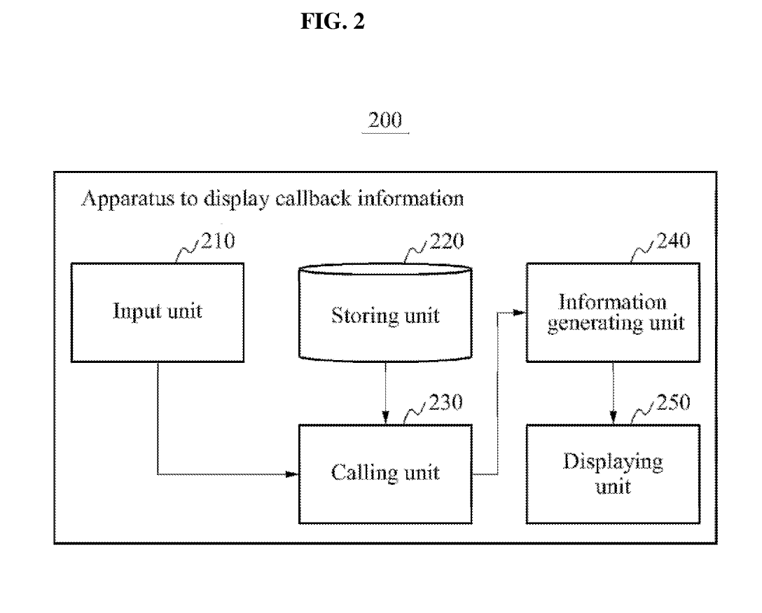

FIG. 2 is a block diagram illustrating a configuration of an apparatus to display callback information according to an exemplary embodiment of the present invention.

Referring to FIG. 2, apparatus 200 to display the callback information includes an input unit 210, a storing unit 220, a calling unit 230, an information generating unit 240, and a displaying unit 250. Further, although not shown in FIG. 2, the apparatus 200 may be installed in a mobile communication terminal, which may include hardware components, such as one or more processors, a memory, a touch screen display, a camera, and the like. Also, the units, modules, elements, devices, applications, and components of the apparatuses, systems, and/or mobile terminals herein described, may include hardware and software, may also include firmware, to perform various operations of the terminal including those described herein, may be combined or remain separate, and may be stored in one or more storage devices or computer-readable media. And, although described herein as a mobile communication terminal, aspects need not be limited thereto such that the mobile communication terminal may be a cellular telephone, a smartphone, a tablet computer, a laptop computer, a desktop computer, and the like.

The storing unit 220 may store, at least one of a screen address and a callback function address with respect to at least one screen of an application. The input unit 210 may receive a request signal requesting at least one screen to be displayed.

The calling unit 230 may obtain a resulting value by calling the callback function address when the callback function address corresponds to a screen address, which may correspond to the request signal. The information generating unit 240 may generate callback information using the resulting value. The displaying unit 250 may display callback information corresponding to the callback function address using the resulting value.

According to an exemplary embodiment of the present invention, the displaying unit 250 may display a screen corresponding to the request signal, and display the callback information in a predetermined area of the screen. However, aspects of the invention are not limited thereto, such that the callback information may be displayed in an area outside of the screen, as a separate screen, and the like. For example, the displaying unit 250 may display the callback information in a form of at least one of an animation, an icon, an image, or the like, when displaying the screen corresponding to the request signal. The displaying unit 250 may also display a function of an application corresponding to the callback information when a selection signal with respect to the callback information is received through the input unit 210.

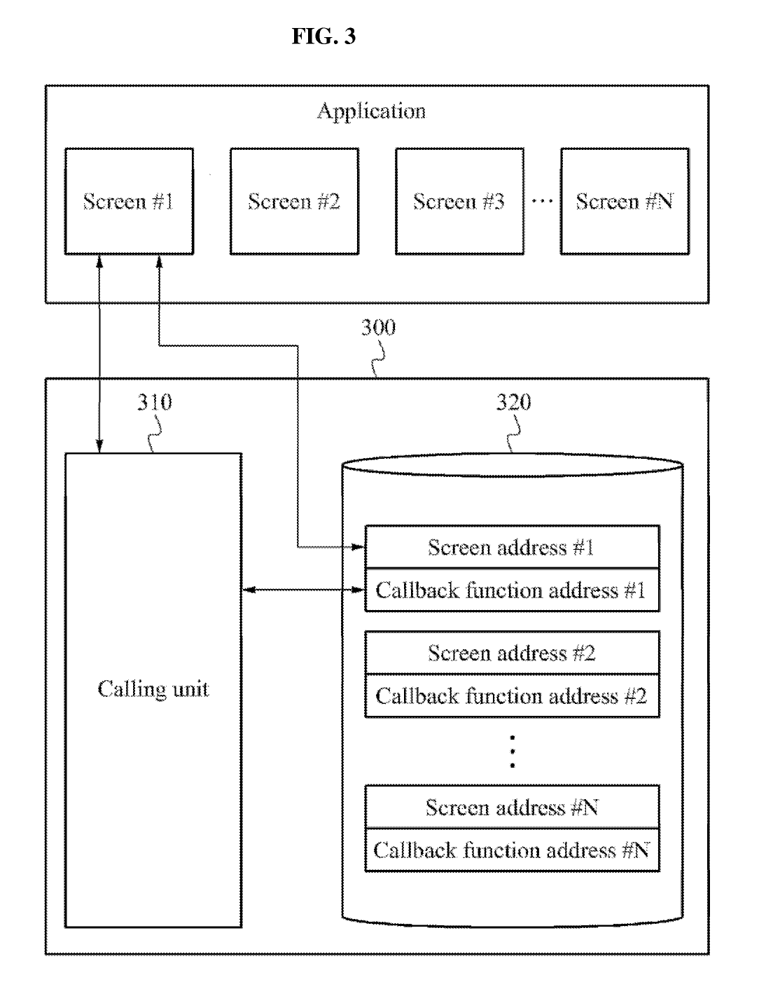

FIG. 3 is a block diagram illustrating information flow between an apparatus to display callback information and an application according to an exemplary embodiment of the present invention.

Referring to FIG. 3, an application may obtain information that may be used to execute a function of a mobile communication terminal or a system by calling a callback function when the function provided by a system or a system function is executed. The application may receive a result when the function of the system is executed. The apparatus 300 to display the callback information may provide a visual display indicating that execution of the function of the system is possible by the application.

The apparatus 300 may store, at least one of a screen address with respect to at least one screen displaying a function of an application and a callback function address configured on at least one screen of the application. The apparatus 300 may store through a matching operation or the like. Further, although not shown in FIG. 3, the apparatus 300 may be installed in a mobile communication terminal, which may include hardware components, such as one or more processors, a memory, a touch screen display, a camera, and the like. Also, the units, modules, elements, devices, applications, and components of the apparatuses, systems, and/or mobile terminals herein described, may include hardware and software, may also include firmware, to perform various operations of the terminal including those described herein, may be combined or remain separate, and may be stored in one or more storage devices or computer-readable media. And, although described herein as a mobile communication terminal, aspects need not be limited thereto such that the mobile communication terminal may be a cellular telephone, a smartphone, a tablet computer, a laptop computer, a desktop computer, and the like.

According to an exemplary embodiment of the present invention, the callback information may include content information displaying at least one function provided by the application. For example, the apparatus 300 may display a visual hint in an intuitive form, such as an icon, an image, a notification, or the like, on a screen as the content information.

The apparatus 300 may extract a screen address from a screen to display notification information. The apparatus 300 may obtain a callback function address from a pair of addresses stored in a storing unit 320. The apparatus 300 may obtain a resulting value by calling the callback function address through a calling unit 310. The apparatus 300 may configure content about the callback information to be displayed using the resulting value.

The apparatus 300 may display, on the screen, the callback information using a screen address stored in the storing unit 320. For example, the apparatus 300 may display a screen corresponding to the screen address and display the callback information in a predetermined area of the screen.

Hereinafter, an example in which callback information is displayed on a screen of a telephone book application according to an exemplary embodiment of the present invention will be described.

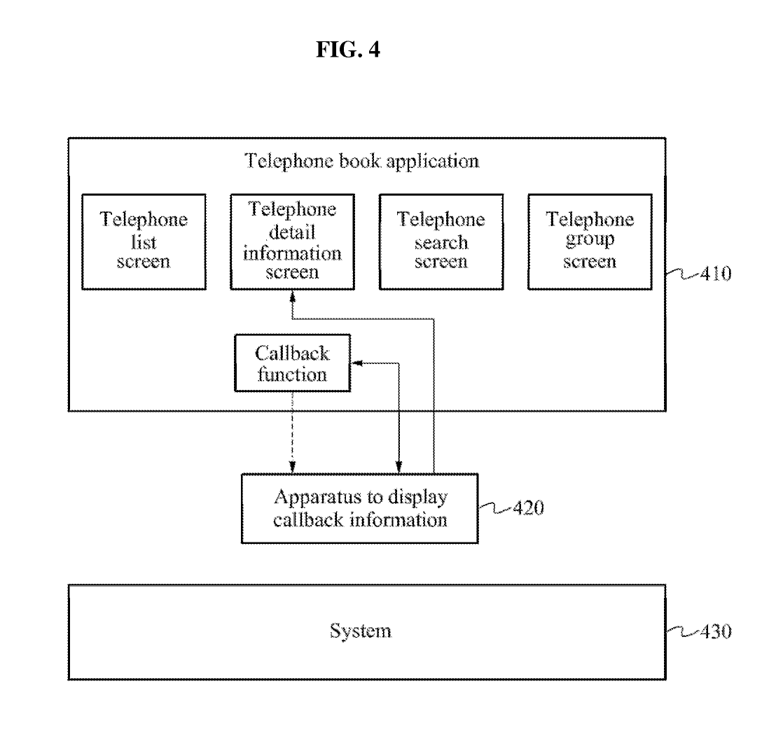

FIG. 4 is a block diagram illustrating a configuration of a mobile communication terminal to display a near field communication (NFC) telephone book transferring icon according to an exemplary embodiment of the present invention.

Referring to FIG. 4, an apparatus 420 to display callback information may store and/or manage a callback function address implemented in a telephone book application 410 provided by a system 430. Further, although not shown in FIG. 4, the apparatus 420 may be installed in a mobile communication terminal, which may include hardware components, such as one or more processors, a memory, a touch screen display, a camera, and the like. Also, the units, modules, elements, devices, applications, and components of the apparatuses, systems, and/or mobile terminals herein described, may include hardware and software, may also include firmware, to perform various operations of the terminal including those described herein, may be combined or remain separate, and may be stored in one or more storage devices or computer-readable media. And, although described herein as a mobile communication terminal, aspects need not be limited thereto such that the mobile communication terminal may be a cellular telephone, a smartphone, a tablet computer, a laptop computer, a desktop computer, and the like.

The telephone book application 410 may include a plurality of screens, such as a telephone book list screen, a telephone book detail information screen, a telephone book search screen, a telephone book group screen, and the like. However, aspects of the invention are not limited thereto, such that additional screens or different screens may be included. A screen providing a function of transmitting a telephone book through NFC may correspond to a screen of the telephone book application 410 including detail information in the descriptions provided therein. More specifically, a screen address of the telephone detail information screen may correspond to a callback function address stored in the apparatus 420. The apparatus 420 may display the callback information corresponding to the callback function address if the callback function address corresponds to the screen address.

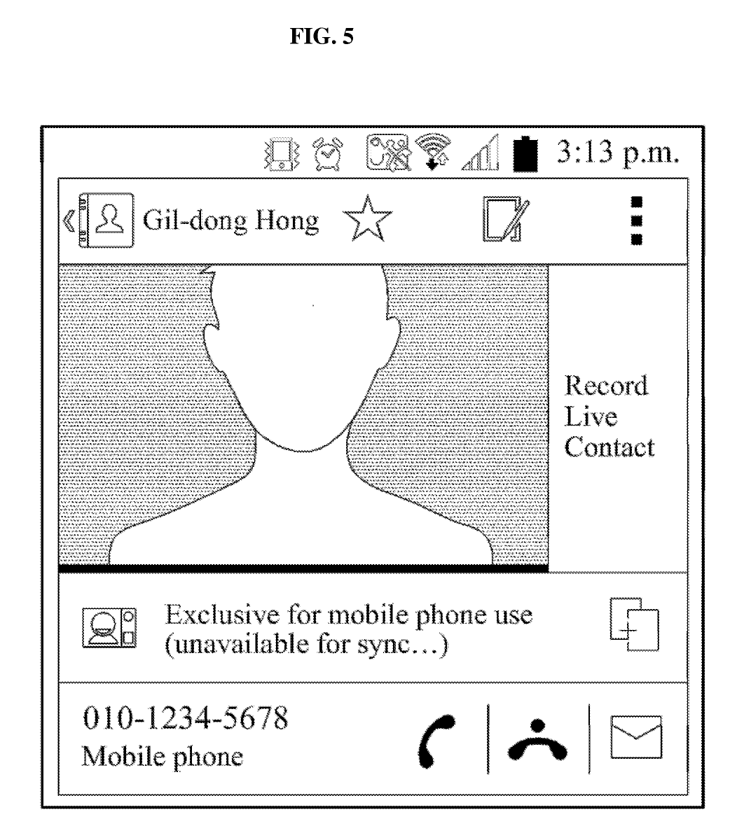

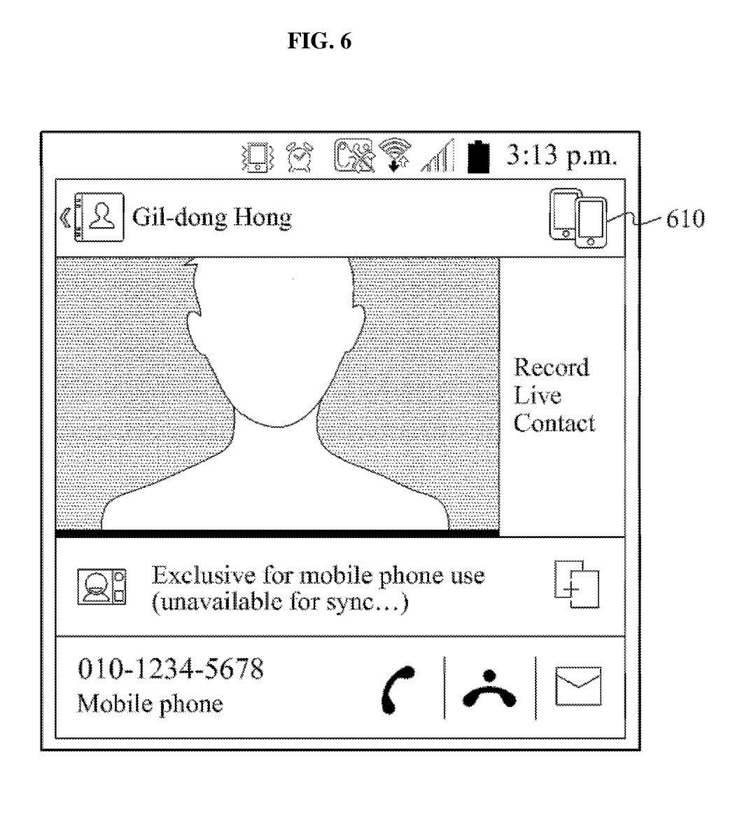

FIG. 5 is a diagram illustrating a screen prior to an NFC telephone book transferring icon being displayed according to an exemplary embodiment of the present invention. FIG. 6 is a diagram illustrating a screen displaying to an NFC telephone book transferring icon according to an exemplary embodiment of the present invention.

An apparatus to display callback information may display the telephone book detail information screen as shown in FIG. 5 when a request signal requesting the telephone book detail information screen of a telephone book application is received. The NFC telephone book transferring icon may be displayed in a predetermined area as callback information 610, as shown in FIG. 6. The callback information 610 may be displayed to indicate that the apparatus may provide a function of transmitting the telephone book information through the NFC on the telephone book detail information screen. According to aspects of the invention, the callback information 610 may be at least one of an icon, an image, an animation, a notification and the like.

The apparatus to display the callback information may obtain a resulting value by calling a callback function address to display, as the callback information 610, information indicating that the telephone book information may be transmitted to the telephone detail information screen through the NFC, and display the callback information 610 on the telephone detail information screen using the resulting value.

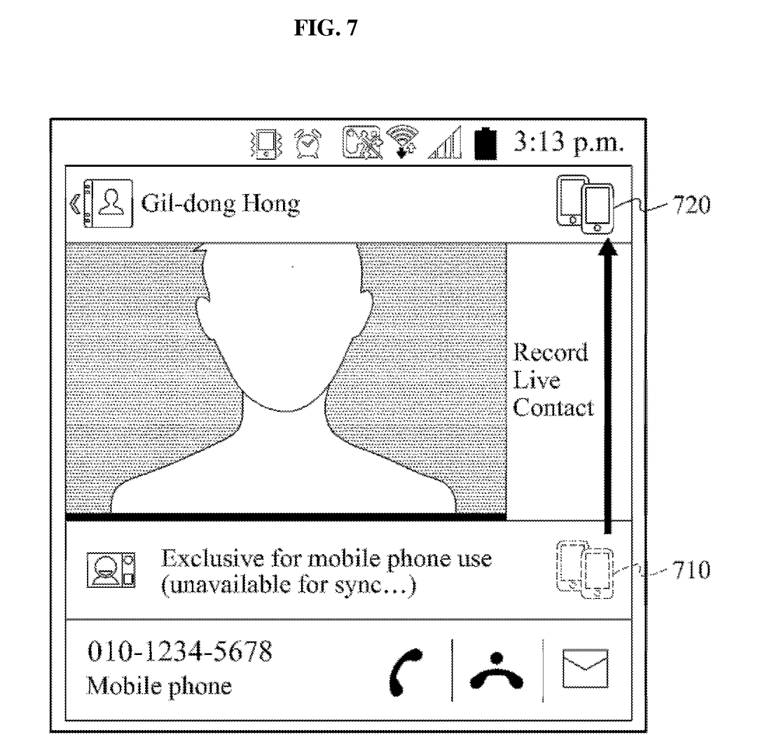

FIG. 7 is a diagram illustrating a screen on which callback information is displayed in a form of an animation according to an exemplary embodiment of the present invention.

An apparatus to display callback information may display the callback information as a visual hint or indicator. The apparatus may display the callback information by calling a callback function address using a resulting value obtained and may provide various visual hints or indicators to enhance perception of a user.

The apparatus to display the callback information may enhance the perception of the user by displaying the callback information in a form of an animation when a screen is accessed. The callback information may be displayed such that the user may recognize that a corresponding function is provided on a screen. For example, the apparatus may display the callback information about a function of transmitting a telephone book through NFC in a form of an icon when accessing a screen, by adding an animation effect of, for example, moving up to a position 720 from a position 710, and the like. However, aspects of the invention are not limited thereto, such that the animation may move in place, in a different direction, change in color, and the like.

The apparatus to display the callback information may display descriptions with respect to a corresponding function when the callback information is selected for the user to verify or determine a function provided in an application. For example, the apparatus may display a description of a function in which information may be transmitted through the NFC when two mobile communication terminals are brought into contact with one another.

Hereinafter, an example in which callback information is displayed on a screen of a camera application according to an exemplary embodiment of the present invention will be described.

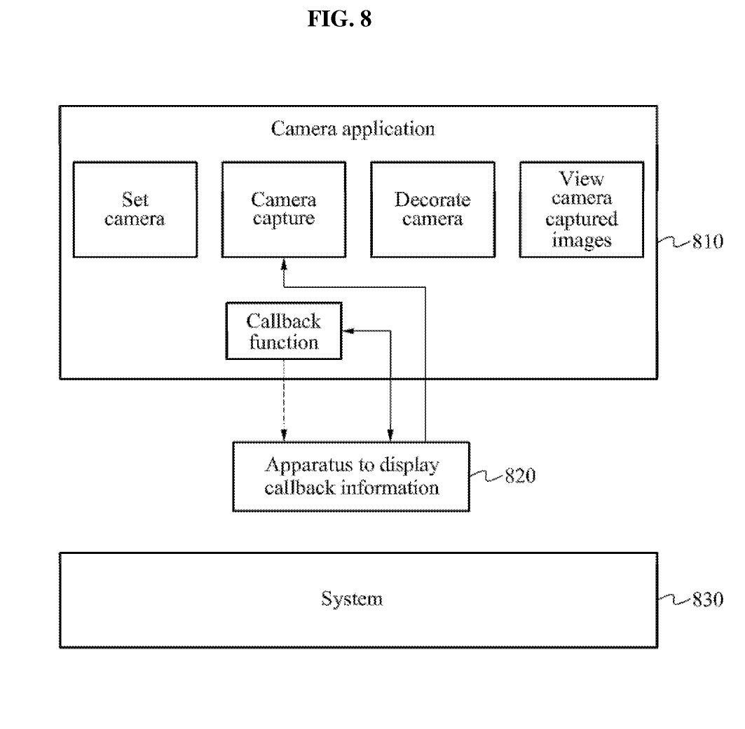

FIG. 8 is a block diagram illustrating a configuration of a mobile communication terminal to display a voice recognition icon of a camera application 810 according to an exemplary embodiment of the present invention.

Referring to FIG. 8, an apparatus 820 to display callback information may store and/or manage a callback function address corresponding to a function implemented in the camera application 810, which may be provided by a system 830. The callback function address may correspond to a screen address of a screen in the camera application 810.

As shown in FIG. 8, the camera application 810 includes a camera setting screen, a camera capture screen, a camera decoration screen, and a view camera captured images screen. However, aspects of the invention are not limited thereto, such that additional or less screens may correspond to the camera application 810. Further, a screen providing a voice recognition function may be provided in the camera capture screen.

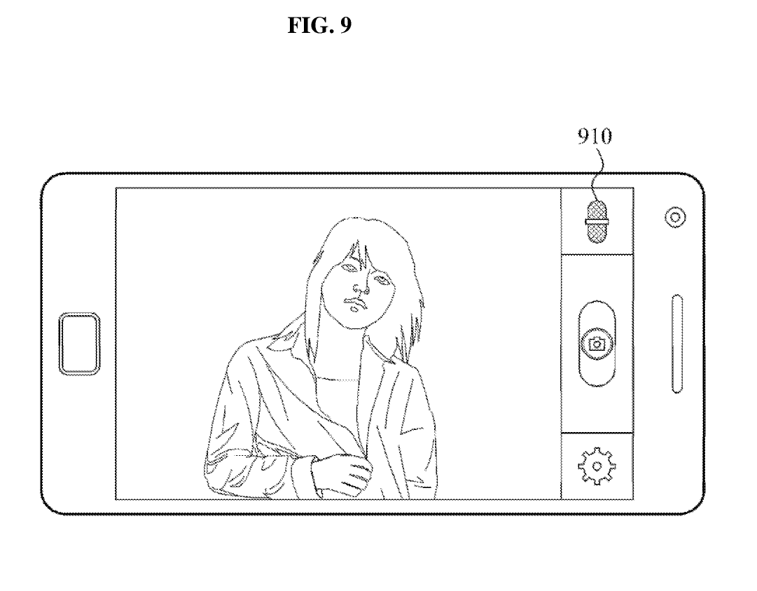

FIG. 9 is a diagram illustrating a screen on which a voice recognition icon is displayed according to an exemplary embodiment of the present invention.

Referring to FIG. 9, an apparatus to display callback information may indicate to a user that a voice recognition camera capture function is available by displaying a microphone icon 910 on a camera capture screen. More specifically, the microphone icon 910 may be displayed to indicate the voice recognition camera capture function, which may allow a built-in camera to capture an image when a command of capture or the like is entered via the voice recognition camera capture function.

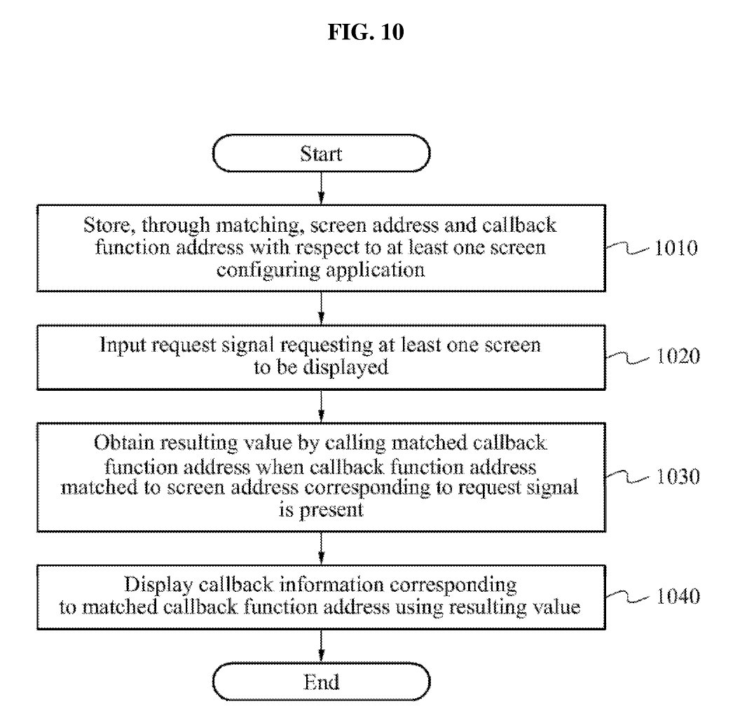

FIG. 10 is a flowchart illustrating a method for displaying callback information according to an exemplary embodiment of the present invention.

Referring to FIG. 10, the apparatus to display the callback information may store at least one of a screen address and a callback function address with respect to at least one screen configuring an application in operation 1010. The stored callback information may store a screen address and matching or corresponding callback function address. In operation 1020, the apparatus receives an input of a request signal to display at least one screen in operation 1020. In operation 1030, when the callback function address is determined to be matched to a screen address corresponding to the request signal, a resulting value may be obtained by calling the matching or corresponding callback function address.

In operation 1040, the apparatus to display the callback information may display callback information corresponding to the matching or corresponding callback function address using the resulting value.

According to an exemplary embodiment of the present invention, an apparatus to display callback information may display visual callback information with respect to a screen in which a callback function may be implemented. The callback information may be automatically or displayed according to an input or a command. Accordingly, a user may more easily recognize availability of a function provided in an application (e.g., voice recognition function in a camera application).

Aspects of the invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media, such as hard disks, floppy disks, and magnetic tape; optical media, such as Compact Disc read-only memory (CD-ROM) discs and Digital Versatile Disc (DVD); magneto-optical media, such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for displaying callback information in a mobile terminal having a processor, comprising:
receiving a request signal for displaying a screen of an application;
obtaining a resulting value when a screen address of the screen corresponds with a callback function address; and
displaying callback information corresponding to the callback function address using the resulting value.

2. The method of claim 1, wherein the callback information comprises at least one of an icon, an animation, and a notification.

3. The method of claim 1, further comprising:
storing the screen address and the callback function address.

4. The method of claim 1, wherein the callback information is displayed on the screen automatically.

5. The method of claim 1, further comprising:
displaying the callback information in an area of the screen.

6. The method of claim 1, further comprising:
displaying a function of an application corresponding to the callback information when a selection signal with respect to the callback information is received through the input unit.

7. The method of claim 1, wherein the request signal is received when a predetermined condition is met.

8. The method of claim 7, wherein the application processes a function of the mobile terminal with respect to the predetermined condition.

9. The method of claim 1, wherein the callback function address corresponds to a function of the mobile terminal that is executable by the application.

10. An apparatus to display callback information, comprising:
an input unit to receive a request signal to display a screen of an application;
a calling unit to obtain a resulting value when a screen address of the screen corresponds with a callback function address; and
a displaying unit to display callback information corresponding to the callback function address using the resulting value.

11. The apparatus of claim 10, wherein the callback information comprises at least one of an icon, an animation, and a notification.

12. The apparatus of claim 10, further comprising:
a storing unit to store the screen address and the callback function address.

13. The apparatus of claim 10, further comprising:
an information generating unit to generate callback information using the resulting value.

14. The apparatus of claim 10, wherein the displaying unit displays the callback information in an area of the screen.

15. The apparatus of claim 10, wherein the displaying unit displays a function of an application corresponding to the callback information when a selection signal with respect to the callback information is received through the input unit.

16. The apparatus of claim 10, wherein the input unit receives the request signal when a predetermined condition is met.

17. The apparatus of claim 10, wherein the display unit displays the callback information automatically.

18. A mobile terminal, comprising:
an application comprising a screen;
a system to provide a function to be used by the application; and
an apparatus to associate a screen address of the screen and a callback function address of the function, to receive a request signal to display the screen, and to obtain a resulting value when the screen address of the screen corresponds with the callback function address.

19. The mobile terminal of claim 18, wherein the application processes the function of the system with respect to the predetermined condition.

20. The mobile terminal of claim 18, wherein the callback information comprises at least one of an icon, an animation, and a notification.
